(19) United States
(12) Patent Application Publication
(10) Pub. No.: US 2025/0333864 A1
(43) Pub. Date: Oct. 30, 2025

(54) ELECTROCATALYST FOR WATER ELECTROLYSIS AND PREPARING METHOD OF THE SAME

(71) Applicants: Korea Electric Power Corporation, Naju-si (KR); Research & Business Foundation SUNGKYUNKWAN UNIVERSITY, Suwon-si (KR)

(72) Inventors: Jung Kyu KIM, Suwon-si (KR); Won Tae HONG, Suwon-si (KR); Hyun Gu HAN, Suwon-si (KR)

(21) Appl. No.: 19/194,757

(22) Filed: Apr. 30, 2025

(30) Foreign Application Priority Data
Apr. 30, 2024 (KR) 10-2024-0057604

(51) Int. Cl. C25B 11/054; C25B 11/067; C25B 11/075

(52) U.S. Cl. CPC C25B 11/054; C25B 11/067; C25B 11/075

(57) ABSTRACT

Discloses are an electrocatalyst for a water electrolysis and a method of preparing the same, which includes a support made of a MXene having a two-dimensional structure; and a transition metal compound located on and heterogeneously bonded to the support, and applies two or more metal phosphides selected from a transition metal group consisting of nickel, iron, molybdenum, cobalt and tungsten as the transition metal compound, thereby increasing electrochemical activity by improving the operation stability and increasing the surface area compared to conventional commercial catalysts.

### CROSS REFERENCE TO RELATED APPLICATION

The present application claims priority to Korean Patent Application No. 10-2024-0057604, filed Apr. 30, 2024, the entire contents of which is incorporated herein for all purposes by this reference.

### BACKGROUND OF THE INVENTION

### Field of the Invention

The disclosure relates to an electrocatalyst for water electrolysis and a method of preparing the same, and more particularly to an electrocatalyst for water electrolysis and a method of preparing the same, in which MXene with excellent electrical conductivity and high surface area is used as a support, and bimetallic phosphide is used as a catalyst.

### Description of the Related Art

A fuel cell is attracting attention as a next-generation energy conversion technology because it has very high power generation efficiency of 40 to 80%, makes low noise, and produces an environmentally friendly reaction by-product of water. However, to commercialize the fuel cell, it is necessary to efficiently supply reactants, i.e., hydrogen and oxygen.

In particular, to supply hydrogen, hydrogen has conventionally been produced by reforming fossil fuels. However, the conventional hydrogen production methods have a problem that the reserves of fossil fuels are not infinite. Therefore, to solve this problem, hydrogen production methods based on water electrolysis are attracting attention.

The water electrolysis is implemented in an electrochemical cell that includes a negative electrode (cathode) where hydrogen evolution reaction (HER) occurs based on a reduction reaction of water, a positive electrode (anode) where oxygen evolution reaction (OER) occurs based on an oxidation reaction of water, and an electrolyte and a separator for ion conduction and short circuit between the two electrodes.

The water electrolysis is classified into a proton exchange membrane (PEM) method used under acidic conditions, and alkaline electrolysis (AEC) and anion exchange membrane (AEM) methods used under alkaline conditions according to the types of electrolytes. In the case of AEM water electrolysis, advantages of high price competitiveness due to use of hydrocarbon polymer membranes and non-precious metal-based catalysts of alkaline water electrolysis and the high operating density and compact design of PEM water electrolysis are implemented in combination. However, the AEM water electrolysis has not reached a commercialization stage.

The HER and OER electrodes exhibit excellent performance under acidic and alkaline conditions, respectively. However, acidic electrolytes may corrode the electrodes. Therefore, in order to induce an economical and highly efficient AEM electrolysis reaction, it is necessary to develop a non-precious metal-based bifunctional material that is stable and applicable to both HER and OER under alkaline conditions.

In particular, the existing oxygen evolution reaction (OER) electrode requires stable durability due to relatively slow reaction speed and high overvoltage, which limits the use of non-precious metal-based catalysts. Accordingly, transition metal phosphides have recently been studied for the reason that can stably induce catalytic reactions under acidic and alkaline conditions with excellent electrical conductivity and high exchange current density.

However, there is difficulty in commercializing the transition metal phosphides due to a small active area and self-agglomeration. Accordingly, further research on an electrocatalyst for the water electrolysis, to which the transition metal phosphides are applied, is required.

### DOCUMENTS OF RELATED ART

(Patent Document 1) Korean Patent No. 10-2499949 (published on Aug. 10, 2022)

### SUMMARY OF THE INVENTION

The disclosure has been conceived to solve the aforementioned problems that the conventional electrocatalyst for water electrolysis has poor economy, stability and performance, and an aspect of the disclosure is to provide an electrocatalyst for AEM water electrolysis and a method of preparing the same, in which a MXene with excellent electrical conductivity and a large surface area is used as a support to induce a wider electrochemically active area, and a bimetallic phosphide is used to provide an active site for effective electron transfer through interactions between heterogeneous metal atoms while exhibiting superior thermodynamic stability and electrical conductivity compared to single metal phosphides.

According to an embodiment of the disclosure, an electrocatalyst for water electrolysis is provided in the form of a support-transition metal compound complex that includes: a support made of a MXene having a two-dimensional structure; and a transition metal compound located on and heterogeneously bonded to the support.

The transition metal compound may include two or more metal phosphides selected from a transition metal group consisting of nickel, iron, molybdenum, cobalt and tungsten.

The electrocatalyst for the water electrolysis may be for a hydrogen evolution reaction (HER) or an oxygen evolution reaction (OER).

The electrocatalyst for the water electrolysis may be applied simultaneously to a positive electrode and a negative electrode of a water electrolysis cell.

The MXene may include a compound based on the following Formula 1:

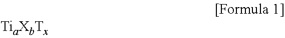

where, ‘a’ is an integer from 2 to 4, ‘b’ is an integer from 1 to 3, and ‘X’ is carbon (C) or nitrogen (N), and ‘Tₓ’ is a functional group (—O, —OH, —F, etc.).

The support may have a surface modified with one or more functional groups selected from a group of functional groups (Tₓ) consisting of —O, —OH and —F.

Further, according to an embodiment of the disclosure, a method of preparing an electrocatalyst for water electrolysis includes: a precursor solution preparation step of preparing a precursor solution by dissolving a transition metal precursor in an organic solvent; and a complex preparation step of preparing an electrocatalyst for water electrolysis by adding a phosphorus precursor and a MXene to the precursor solution.

The transition metal precursor may include two or more metal compounds including a metal element selected from a transition metal group consisting of nickel, iron, molybdenum, cobalt and tungsten.

The phosphorus precursor may include an alkyl phosphine-based material.

The alkyl phosphine may include one or more selected from a group consisting of triethyl phosphine, tributyl phosphine, trioctyl phosphine, triphenyl phosphine, and tricyclohexyl phosphine.

The transition metal precursor includes a combination of metal acetylacetonates (nickel acetylacetonate, iron acetylacetonate, molybdenum acetylacetonate, cobalt acetylacetonate, and tungsten acetylacetonate).

The method may further include a MXene defect introduction step of inducing surface defects in the MXene by mixing a MXene precursor and strong acid before performing the complex preparation step.

### BRIEF DESCRIPTION OF THE DRAWINGS

FIG. 1 is a flowchart showing a preparing method of an electrocatalyst for water electrolysis according to the disclosure.

FIG. 2 is a conceptual diagram showing a synthesis process sequence of a MXene support in a preparing method of an electrocatalyst for water electrolysis according to the disclosure.

FIG. 3 is a conceptual diagram showing a sequence of supporting a transition metal phosphide on a MXene support in a preparing method of an electrocatalyst for water electrolysis according to the disclosure.

FIG. 4a shows a MXene (Ti₃C₂T_{X}) support, which are photographed by a transmission electron microscope (TEM) at 1 nm scale.

FIG. 4b shows electrocatalysts for water electrolysis prepared by growing an embodiment 2 (NiCoP@Ti₃C₂Tₓ) for 10 seconds, which are photographed by a TEM at 50 nm scale.

FIG. 4c shows electrocatalysts for water electrolysis prepared by growing an embodiment 2 (NiCoP@Ti₃C₂Tₓ) for 10 seconds, which are photographed by a TEM at 1 nm scale (Noted schematic diagram on calculating the intracrystalline spacing on the right).

FIG. 4d shows electrocatalysts for water electrolysis prepared by growing an embodiment 2 (NiCoP@Ti₃C₂Tₓ) for 2 hours, which are photographed by the TEM at 100 nm scale.

FIG. 4e shows electrocatalysts for water electrolysis prepared by growing an embodiment 2 (NiCoP@Ti₃C₂Tₓ) for 2 hours, which are photographed by the TEM at 10 nm scale.

FIG. 4f shows electrocatalysts for water electrolysis prepared by growing an embodiment 2 (NiCoP@Ti₃C₂Tₓ) for 2 hours, which are photographed by the TEM at 1 nm scale with a mark of NiCoP.

FIG. 4g shows electrocatalysts for water electrolysis prepared by growing an embodiment 2 (NiCoP@Ti₃C₂Tₓ) for 2 hours, which are photographed by the TEM at 1 nm scale with a mark of Ti₃C₂Tₓ.

FIG. 4h shows a selected area electron diffraction (SAED) pattern taken using energy-dispersive X-ray spectroscopy (EDX) coupled to the TEM image of an embodiment 2 (NiCoP@Ti₃C₂Tₓ) for 2 hours.

FIG. 4i shows an image containing all elements taken using energy-dispersive X-ray spectroscopy (EDX) coupled to the TEM image of an embodiment 2 (NiCoP@Ti₃C₂Tₓ) for 2 hours.

FIG. 4j shows an image on Nickel taken using energy-dispersive X-ray spectroscopy (EDX) coupled to the TEM image of an embodiment 2 (NiCoP@Ti₃C₂Tₓ) for 2 hours.

FIG. 4k shows an image on Cobalt taken using energy-dispersive X-ray spectroscopy (EDX) coupled to the TEM image of an embodiment 2 (NiCoP@Ti₃C₂Tₓ) for 2 hours.

FIG. 4l shows an image on Phosphorus taken using energy-dispersive X-ray spectroscopy (EDX) coupled to the TEM image of an embodiment 2 (NiCoP@Ti₃C₂Tₓ) for 2 hours.

FIG. 4m shows an image on Titanium taken using energy-dispersive X-ray spectroscopy (EDX) coupled to the TEM image of an embodiment 2 (NiCoP@Ti₃C₂Tₓ) for 2 hours.

FIG. 4n shows an image on Carbon taken using energy-dispersive X-ray spectroscopy (EDX) coupled to the TEM image of an embodiment 2 (NiCoP@Ti₃C₂Tₓ) for 2 hours.

FIG. 5 is a diagram showing shapes varied depending on nickel-cobalt compositions in an electrocatalyst for the water electrolysis according to the disclosure.

FIG. 6a shows a TEM image of an electrocatalyst for water electrolysis to show morphology on Ni₂P@Ti₃C₂Tₓ complex at 100 nm scale.

FIG. 6b shows a TEM image of an electrocatalyst for water electrolysis to show morphology on Ni₂P@Ti₃C₂Tₓ complex at 2 nm scale with mark of Ni₂P.

FIG. 6c shows a TEM image of an electrocatalyst for water electrolysis to show morphology on Ni_{1.5}Co_{0.5}P@Ti₃C₂Tₓ complex at 100 nm scale.

FIG. 6d shows a TEM image of an electrocatalyst for water electrolysis to show morphology on Ni_{1.5}Co_{0.5}P@Ti₃C₂Tₓ complex at 2 nm scale with mark of Ni_{1.5}Co_{0.5}P.

FIG. 6e shows a TEM image of an electrocatalyst for water electrolysis to show morphology on Ni_{0.5}Co_{1.5}P@Ti₃C₂Tₓ complex at 100 nm scale.

FIG. 6f shows a TEM image of an electrocatalyst for water electrolysis to show morphology on Ni_{0.5}Co_{1.5}P@Ti₃C₂ complex at 2 nm scale with mark of Ni_{0.5}Co_{1.5}P.

FIG. 6g shows a TEM image of an electrocatalyst for water electrolysis to show morphology on Co₂P@Ti₃C₂Tₓ complex at 100 nm scale.

FIG. 6h shows a TEM image of an electrocatalyst for water electrolysis to show morphology on Co₂P@Ti₃C₂ complex at 2 nm scale with mark of Co₂P.

FIG. 7 shows difference in crystal structure according to nickel-cobalt content (Ni_{1.5}Co_{0.5}P@Ti₃C₂Tₓ complex (embodiment 1), NiCoP@Ti₃C₂Tₓ (embodiment 2), Ni_{0.5}Co_{1.5}P@Ti₃C₂Tₓ (embodiment 3), Ni₂P@Ti₃C₂Tₓ (comparative example 1), Co₂P@Ti₃C₂Tₓ (comparative example 2)) based on X-ray diffraction (XRD) analysis.

FIG. 8a shows oxidation states related to Ni 2p, analyzed by X-ray photoelectron spectroscopy (XPS) along with the comparative examples 1 and 2 and NiCoP synthesized without the MXene support to analyze the oxidation states of NiCoP@Ti₃C₂Tₓ complex (embodiment 2).

FIG. 8b shows an enlarged view of FIG. 8a in the 850 eV to 860 eV range.

FIG. 8c shows oxidation states related to Co 2p, analyzed by X-ray photoelectron spectroscopy (XPS) along with the comparative examples 1 and 2 and NiCoP synthesized without the MXene support to analyze the oxidation states of NiCoP@Ti₃C₂Tₓ complex (embodiment 2).

FIG. 8d shows an enlarged view of FIG. 8c in the 850 eV to 860 eV range.

FIG. 9a shows oxidation states related to P 2p, analyzed by X-ray photoelectron spectroscopy (XPS) along with NiCoP synthesized without the MXene support as a comparison group and MXene (Ti₃C₂Tₓ) as a support to analyze the oxidation states of NiCoP@Ti₃C₂Tₓ complex (embodiment 2).

FIG. 9b shows oxidation states related to C is, analyzed by X-ray photoelectron spectroscopy (XPS) along with NiCoP synthesized without the MXene support as a comparison group and MXene (Ti₃C₂Tₓ) as a support to analyze the oxidation states of NiCoP@Ti₃C₂Tₓ complex (embodiment 2).

FIG. 9c shows oxidation states related to Ti 2p, analyzed by X-ray photoelectron spectroscopy (XPS) along with NiCoP synthesized without the MXene support as a comparison group and MXene (Ti₃C₂Tₓ) as a support to analyze the oxidation states of NiCoP@Ti₃C₂Tₓ complex (embodiment 2).

FIG. 10a shows polarization curves measured through linear sweep voltammetry (LSV) for water electrolysis HER in 1M KOH (˜pH 13.9) electrolyte by measuring electrochemical response currents of the embodiments and comparative examples including NiCoP@Ti₃C₂Tₓ (embodiment 2) complex and commercialized HER platinum catalysts (Pt/C) as a comparative group.

FIG. 10b shows Tafel slopes plotted based on the polarization curves for water electrolysis HER in 1M KOH (˜pH 13.9) electrolyte by measuring electrochemical response currents of the embodiments and comparative examples including NiCoP@Ti₃C₂Tₓ (embodiment 2) complex and commercialized HER platinum catalysts (Pt/C) as a comparative group.

FIG. 10c shows overpotential graphs at specific current density plotted based on the polarization curves of activities for water electrolysis HER in 1M KOH (˜pH 13.9) electrolyte by measuring electrochemical response currents of the embodiments and comparative examples including NiCoP@Ti₃C₂Tₓ (embodiment 2) complex and commercialized HER platinum catalysts (Pt/C) as a comparative group.

FIG. 11a shows Nyquist plot based on electrochemical impedance spectroscopy (EIS) measurement for water electrolysis HER in 1 M KOH (˜pH 13.9) electrolyte by measuring electrochemical response currents of the embodiments and comparative examples including NiCoP@Ti₃C₂Tₓ (embodiment 2) complex and commercialized HER platinum catalysts (Pt/C) as a comparative group.

FIG. 11b shows electrochemical double-layer capacitance per unit area based on electrochemical active surface area (ECSA) measurement for water electrolysis HER in 1 M KOH (˜pH 13.9) electrolyte by measuring electrochemical response currents of the embodiments and comparative examples including NiCoP@Ti₃C₂Tₓ (embodiment 2) complex and commercialized HER platinum catalysts (Pt/C) as a comparative group.

FIG. 11c shows long-term operating stability evaluation graphs of activities for water electrolysis HER in 1 M KOH (˜pH 13.9) electrolyte by measuring electrochemical response currents of NiCoP@Ti₃C₂Tₓ (embodiment 2) complex and commercialized HER platinum catalysts (Pt/C) as a comparative group.

FIG. 12a shows polarization curves measured through linear sweep voltammetry (LSV) for water electrolysis OER in 1M KOH (˜pH 13.9) electrolyte by measuring electrochemical response currents of the embodiments 1 to 3 and comparative examples 1 to 2 including NiₓCo_{y}P@Ti₃C₂Tₓ complex according to nickel-cobalt compositions and commercialized OER ruthenium catalysts (RuO₂).

FIG. 12b shows Tafel slopes plotted based on the polarization curves for water electrolysis OER in 1M KOH (˜pH 13.9) electrolyte by measuring electrochemical response currents of the embodiments 1 to 3 and comparative examples 1 to 2 including NiₓCo_{y}P@Ti₃C₂Tₓ complex according to nickel-cobalt compositions and commercialized OER ruthenium catalysts (RuO₂).

FIG. 12c shows overpotential graphs at specific current density plotted based on the polarization curves of activities for water electrolysis OER in 1M KOH (˜pH 13.9) electrolyte by measuring electrochemical response currents of the embodiments 1 to 3 and comparative examples 1 to 2 including NiₓCo_{y}P@Ti₃C₂Tₓ complex according to nickel-cobalt compositions and commercialized OER ruthenium catalysts (RuO₂).

FIG. 13a shows Nyquist plot based on electrochemical impedance spectroscopy (EIS) measurement for water electrolysis OER in 1 M KOH (˜pH 13.9) electrolyte by measuring electrochemical response currents of the embodiments 1 to 3 and comparative examples 1 to 2 including NiₓCo_{y}P@Ti₃C₂Tₓ complex according to nickel-cobalt compositions and commercialized OER ruthenium catalysts (RuO₂).

FIG. 13b shows electrochemical double-layer capacitance per unit area based on electrochemical active surface area (ECSA) measurement for water electrolysis OER in 1 M KOH (˜pH 13.9) electrolyte by measuring electrochemical response currents of the embodiments 1 to 3 and comparative examples 1 to 2 including NiₓCo_{y}P@Ti₃C₂Tₓ complex according to nickel-cobalt compositions and commercialized OER ruthenium catalysts (RuO₂).

FIG. 13c shows long-term operating stability evaluation graphs of activities for water electrolysis OER in 1 M KOH (˜pH 13.9) electrolyte by measuring electrochemical response currents of the embodiments 1 to 3 and comparative examples 1 to 2 including NiₓCo_{y}P@Ti₃C₂Tₓ complex according to nickel-cobalt compositions and commercialized OER ruthenium catalysts (RuO₂).

FIG. 14a shows polarization curves based on current density change according to potential (V) change, as comparative analysis results of the entire water electrolysis reaction in 1 M KOH electrolyte using NiCoP@Ti₃C₂Tₓ, i.e., an excellent bifunctional catalyst for HER and OER as an oxidation electrode and a reduction electrode and that in commercial Pt/C (reduction electrode, HER)—RuO₂ (oxidation electrode, OER).

FIG. 14b shows long-term operating stability based on the current density change over time, as comparative analysis results of the entire water electrolysis reaction in 1 M KOH electrolyte using NiCoP@Ti₃C₂Tₓ, i.e., an excellent bifunctional catalyst for HER and OER as an oxidation electrode and a reduction electrode and that in commercial Pt/C (reduction electrode, HER)—RuO₂ (oxidation electrode, OER).

FIG. 14c shows quantitative evaluation of hydrogen gas (H₂) and oxygen gas (O₂), as comparative analysis results of the entire water electrolysis reaction in 1 M KOH electrolyte using NiCoP@Ti₃C₂Tₓ, i.e., an excellent bifunctional catalyst for HER and OER as an oxidation electrode and a reduction electrode and that in commercial Pt/C (reduction electrode, HER)—RuO₂ (oxidation electrode, OER).

### DETAILED DESCRIPTION OF THE INVENTION

Hereinafter, exemplary embodiments of the disclosure will be described in detail with reference to the accompanying drawings.

The disclosure may be modified in various ways and have various embodiments, and thus specific embodiments will be illustrated by way of example in the accompanying drawings and specifically described in the detailed description. It should be understood, however, that the drawings and descriptions are not intended to limit the disclosure to the specific embodiments, but cover all modifications, equivalents, and alternatives that fall within the spirit and scope of the disclosure.

Although the terms “first,” “second,” etc. may be used herein to describe various components, such components should not be construed as limited by these terms. These terms are only used to distinguish one component from another. For example, a first component may be termed a second component, and the second component may also be termed the first component, without departing from the scope of the disclosure.

The terms “and/or” may include combinations of a plurality of related described items or any of a plurality of related described items.

When a component is described as being “connected” or “coupled” to another component, it should be understood that the component may be directly connected or joined to another component but intervening components may be present therebetween. However, when a component is described as being “directly connected” or “directly coupled” to another component, it should be understood that there are no intervening components therebetween.

The terminology used herein is for the purpose of describing particular embodiments only and is not intended to limit the disclosure. As used herein, the singular forms are intended to include the plural forms as well, unless the context clearly indicates otherwise.

It will be further understood that the terms “include” and/or “have” when used herein specify the presence of stated features, numbers, steps, operations, components, parts, and/or combinations thereof, but do not preclude the presence or addition of one or more other features, numbers, steps, operations, components, parts, and/or combinations thereof.

Unless otherwise defined, all terms including technical and scientific terms used herein have the same meaning as commonly understood by a person of ordinary skill in the art to which the disclosure pertains. It will be further understood that terms defined in commonly used dictionaries should be interpreted as having a meaning consistent with their meaning in the context of the related art and will not be interpreted in an idealized or overly formal sense unless explicitly defined herein.

In addition, the embodiments set forth herein are provided for more complete descriptions to a person having an ordinary knowledge in the art, and the shape, size, etc. of components in the accompanying drawings may be exaggerated for clarity.

An electrocatalyst for water electrolysis according to a first embodiment of the disclosure is configured by a support-transition metal compound complex that includes a support made of a MXene having a two-dimensional structure, and a transition metal compound located on and heterogeneously bonded to the support.

The transition metal compound uses transition metal phosphide, and thus stably induces HER and OER catalytic reactions under alkaline conditions with excellent electrical conductivity and high exchange current density.

Transition metal compound includes two or more transition metal phosphides selected from a transition metal group consisting of nickel, iron, molybdenum, cobalt, and tungsten.

The transition metal phosphide may be prepared by reacting a transition metal precursor and a phosphorus precursor according to conventionally known stoichiometry.

For example, the transition metal precursor may include one or more selected from the group consisting of nickel acetylacetonate, iron acetylacetonate, molybdenum acetylacetonate, cobalt acetylacetonate, and tungsten acetylacetonate, and most preferably cobalt acetylacetonate and nickel acetylacetonate, which have the best activity compared to other precursors.

The phosphorus precursor may include an alkyl phosphine-based material, and the alkyl phosphine may include one or more selected from the group consisting of triethyl phosphine, tributyl phosphine, trioctyl phosphine, triphenyl phosphine, and tricyclohexyl phosphine, and most preferably trioctyl phosphine (TOP), which has the best activity compared to other precursors.

The MXene is prepared by mixing a strong acid alone with or mixing a strong acid and a fluoride salt simultaneously with a titanium inorganic compound (TiₐAX_{b}), which has a layered hexagonal structure called a “MAX phase,” to remove metal (A) from the titanium inorganic compound (TiₐAX_{b}).

Here, ‘a’ is an integer from 2 to 4, ‘A’ is a transition metal, ‘b’ is an integer from 1 to 3, and ‘X’ may be carbon (C) or nitrogen (N).

The strong acid may include a combination of generally known acid compounds such as hydrofluoric acid (HF), hydrochloric acid (HCl), iodic acid (HI), sulfuric acid (H₂SO₄), and nitric acid (HNO₃), and most preferably hydrofluoric acid (HF), which has the best etching performance compared to other strong acids.

Further, the fluoride salt that is mixed with the strong acid and acts as an etching solution is used to remove the metal (A) from the titanium inorganic compound. For example, the fluoride salt may include lithium fluoride (LiF), sodium fluoride (NaF), magnesium fluoride (MgF₂), strontium fluoride (SrF₂), beryllium fluoride (BeF₂), calcium fluoride (CaF₂), ammonium fluoride (NH₄F), ammonium difluoride (NH₄HF₂), ammonium hexafluoroaluminate ((NH₄)₃AlF₆), or a combination thereof.

For example, the titanium inorganic compound includes one or more selected from the group consisting of Ti₂CdC, Ti₂AlC, Ti₂GaC, Ti₂InC, Ti₂TIC, Ti₂AlN, Ti₂GaN, Ti₂InN, Ti₂GeC, Ti₂SnC, Ti₂PbC, Ti₃AlC₂, Ti₃SiC₂, Ti₃GeC₂, Ti₃SnC₂, Ti₄AlN₃, Ti₄GaC₃, Ti₄SiC₃, and Ti₄GeC₃, and is not limited thereto, but most preferably titanium aluminum carbide (Ti₃AlC₂), which has a superior reaction rate compared to other inorganic compounds.

The electrocatalyst for the water electrolysis is for a hydrogen evolution reaction or an oxygen evolution reaction to be applied to both positive and negative electrodes for anion exchange membrane (AEM) water electrolysis.

In other words, the electrocatalyst for the water electrolysis with the support-transition metal compound complex that includes the support and the transition metal compound is simultaneously applied to the positive and negative electrodes of a water electrolysis cell, thereby providing excellent performance without using the catalyst, which contains precious metal or precious metal oxide, in the positive electrode and the negative electrode, respectively.

Further, the electrocatalyst for the water electrolysis with the support-transition metal compound complex that includes the support and the transition metal compound may be applied simultaneously to the positive and negative electrodes of the water electrolysis cell, and maintain catalytic properties because the transition metal compound is formed on and stably bonded to the support.

The MXene includes a compound based on the following Chemical Formula 1, and may include two or more kinds of components according to the Chemical Formula 1.

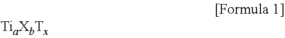

Here, ‘a’ is an integer from 2 to 4, ‘b’ is an integer from 1 to 3, and ‘X’ is carbon (C) or nitrogen (N).

The surface of the support may be modified with one or more functional groups selected from a functional group (Tₓ) consisting of —O, —OH and —F.

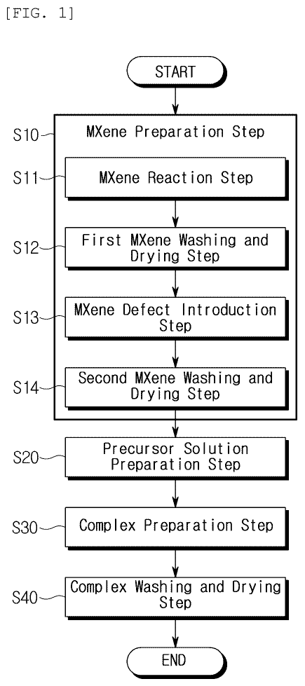

Referring to FIGS. 1 to 3, a method of preparing an electrocatalyst for water electrolysis according to a second embodiment of the disclosure includes a precursor solution preparation step S20 of preparing a precursor solution by dissolving a transition metal precursor in an organic solvent, and a complex preparation step S30 of preparing an electrocatalyst for water electrolysis by adding a phosphorus precursor and the MXene to the precursor solution.

Further, the method of preparing the electrocatalyst for water electrolysis according to the second embodiment of the disclosure further includes a complex washing and drying step S40 of repeatedly washing the electrocatalyst for the water electrolysis by separating the electrocatalyst for the water electrolysis prepared in the complex preparation step S30, adding it to the organic solvent, and repeatedly performing centrifugation.

The organic solvent contains ethanol and hexane, and removes hydrophilic residues or hydrophobic residues formed on the surface of the electrocatalyst for the water electrolysis.

The transition metal precursor includes two or more metal compounds that contains metal selected from the group consisting of nickel, iron, molybdenum, cobalt, and tungsten.

The phosphorus precursor may include an alkyl phosphine-based material.

The alkyl phosphine may include one or more selected from the group consisting of triethyl phosphine, tributyl phosphine, trioctyl phosphine, triphenyl phosphine, and tricyclohexyl phosphine.

Before performing the complex preparation step S30, the MXene is prepared in the following sequence:
1) a MXene reaction step S11, in which a strong acid alone or a strong acid with a fluoride salt are added to the titanium inorganic compound and stirred in a reactor for 24 to 48 hours at a temperature of 30° C. or higher and 70° C. or lower to prepare the MXene
2) a first MXene washing and drying step S12, in which the MXene prepared in the MXene reaction step S11 is dispersed in distilled water (DI Water) and then washed and freeze-dried through a centrifugal process
3) a MXene defect introduction step S13, in which a strong acid solution is added to the MXene washed in the MXene washing and drying step S12 to induce surface defects in the MXene
4) a second MXene washing and drying step S14, in which the MXene processed in the MXene defect introduction step S13 is dispersed in the DI Water, washed through the centrifugal process, and then dried under reduced pressure in a vacuum to obtain the MXene with reduced impurities.

For example, the titanium inorganic compound includes one or more selected from the group consisting of Ti₂CdC, Ti₂AlC, Ti₂GaC, Ti₂InC, Ti₂TiC, Ti₂AlN, Ti₂GaN, Ti₂InN, Ti₂GeC, Ti₂SnC, Ti₂PbC, Ti₃AlC₂, Ti₃SiC₂, Ti₃GeC₂, Ti₃SnC₂, Ti₄AlN₃, Ti₄GaC₃, Ti₄SiC₃, and Ti₄GeC₃, and is not limited thereto, but most preferably titanium aluminum carbide (Ti₃AlC₂), which has a superior reaction rate compared to other inorganic compounds.

In the MXene reaction step, the strong acid alone or the fluoride salt that is mixed with the strong acid and acts as an etching solution is used to remove the metal (A) from the titanium inorganic compound. For example, the strong acid may include hydrofluoric acid (HF), hydrochloric acid (HCl), iodic acid (HI), sulfuric acid (H₂SO₄) and nitric acid (HNO₃), and the fluoride salt may include lithium fluoride (LiF), sodium fluoride (NaF), magnesium fluoride (MgF₂), strontium fluoride (SrF₂), beryllium fluoride (BeF₂), calcium fluoride (CaF₂), ammonium fluoride (NH₄F), ammonium difluoride (NH₄HF₂), and ammonium hexafluoroaluminate ((NH₄)₃AlF₆), but is not limited thereto, and most preferably hydrofluoric acid (HF), which exhibits the best etching performance compared to other strong acids.

### 1. Experimental Example

Below, the results of evaluating and comparing physical properties between the electrocatalysts for the water electrolysis, prepared by the method of preparing the electrocatalysts for the water electrolysis according to the disclosure (embodiments) and the electrocatalysts for the water electrolysis according to the related art (comparative examples) will be described.

### Embodiments and Comparative Examples

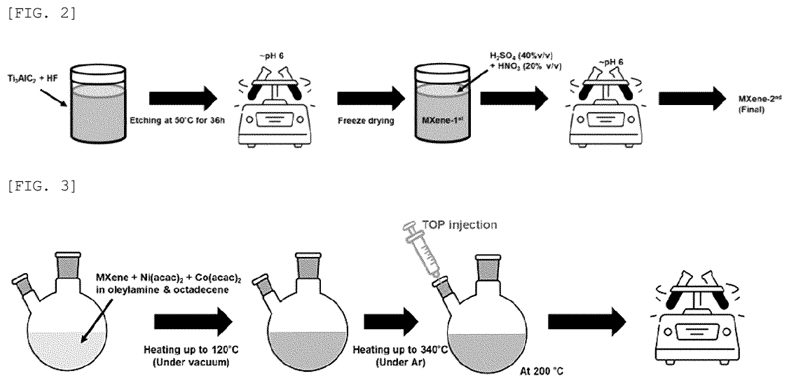

### MXene Preparation Step, S10 (See FIG. 2)

First, to prepare the MXene, a mixture solution was prepared by adding 1 g of titanium aluminum carbide (Ti₃AlC₂), i.e., a titanium inorganic compound to 10 mL of hydrofluoric acid (HF), and the mixture solution was stirred in a reactor for 36 hours at 50° C. to etch a titanium inorganic compound and prepare the MXene, thereby performing a MXene reaction step S11 of preparing the MXene.

Next, the MXene prepared in the MXene reaction step S11 was dispersed in the distilled water (DI Water), washed to have a pH of 6 through a centrifugation process in which centrifugation was repeated at a speed of 10000 rpm for 10 minutes, and dried by a freeze drier, thereby performing a first MXene washing and drying step S12.

Next, after the first MXene washing and drying step S12, 10 mL of sulfuric acid-nitric acid mixed aqueous solution (40% sulfuric acid and 20% nitric acid by volume) was added to a prepared powdered MXene sample, and post-processed at room temperature for 30 seconds to induce surface defects of the MXene, thereby performing the MXene defect introduction step.

Next, the MXene prepared in the MXene defect introduction step S13 was dispersed in the distilled water (DI Water), washed to have a pH of 6 through the centrifugation process in which centrifugation was repeated at a speed of 10000 rpm for 10 minutes, and dried by the freeze drier, thereby performing a second MXene washing and drying step S14 to prepare the MXene (Ti₃C₂Tₓ).

### Complex Preparation (See FIG. 3).

After performing the MXene preparation step S10, nickel acetylacetonate (Ni(acac)₂) and cobalt acetylacetonate (Co(acac)₂) as transition metal precursors, 200 mg of MXene as a support, 25.6 mL of oleylamine as organic ligand, and 18 mL of 1-octadecene as an organic solvent were mixed in a 100 mL flask, and heated at a temperature of 120° C. for 30 minutes under a vacuum condition to remove moisture, thereby performing the precursor solution preparation step S20 of preparing the precursor solution.

In this process, Ni₂P/Ti₃C₂Tₓ (comparative example 1), Ni_{1.5}Co_{0.5}P/Ti₃C₂Tₓ (embodiment 1), NiCoP/Ti₃C₂Tₓ (embodiment 2), Ni_{0.5}Co_{1.5}P/Ti₃C₂Tₓ (embodiment 3), and Co₂P/Ti₃C₂Tₓ (comparative example 2) are prepared by controlling the amount of Ni(acac)₂ and Co(acac)₂ to a total of 200 mg at weight ratios of 100:0, 75:25, 50:50, 25:75, and 0:100, respectively.

Next, the precursor solution was heated up to 200° C. under the vacuum condition to remove moisture, and 2 mL of tri-n-octylphosphine was injected as a phosphorus precursor into the precursor solution at 200° C. in an argon atmosphere. After raising temperature up to 340° C. at a rate of about 10° C./minute, the solution was performed for less than 2 hours and 30 minutes and cooled to room temperature, thereby performing the complex preparation step S30 of preparing the electrocatalyst for the water electrolysis as the complex of transition metal phosphide and the MXene in the solution.

After performing the complex preparation step S30, the electrocatalyst for the water electrolysis was separated from the solution, added to an ethanol-hexane solution (ethanol:hexane=3:1 by volume), and undergoes the centrifugation process in which the centrifugation was repeated at a speed of 10000 rpm for 10 minutes in a centrifuge, thereby performing the complex washing and drying step S40 of repeatedly washing the electrocatalyst for the water electrolysis and drying the complex through the freeze drier.

### 2. Physical Property Evaluation

Below, results of evaluating and comparing the physical properties of the electrocatalysts for the water electrolysis prepared by the preparing method according to the disclosure, such as Ni_{1.5}Co_{0.5}P/Ti₃C₂Tₓ (embodiment 1), NiCoP/Ti₃C₂Tₓ (embodiment 2), and Ni_{0.5}Co_{1.5}P/Ti₃C₂Tₓ (embodiment 3) and the comparative examples such as Ni₂P/Ti₃C₂Tₓ (comparative example 1), and Co₂P/Ti₃C₂Tₓ (comparative example 2) will be described.

### Electron Microscope

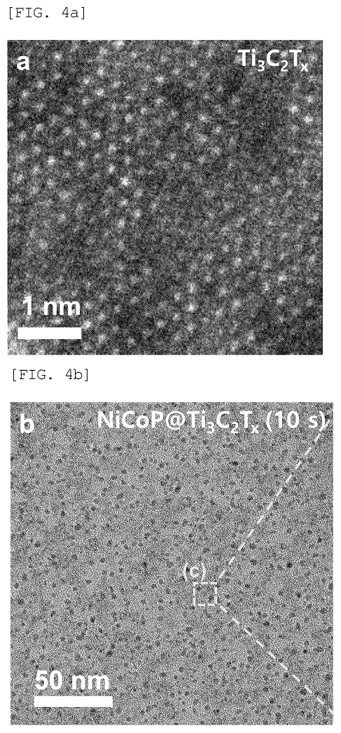

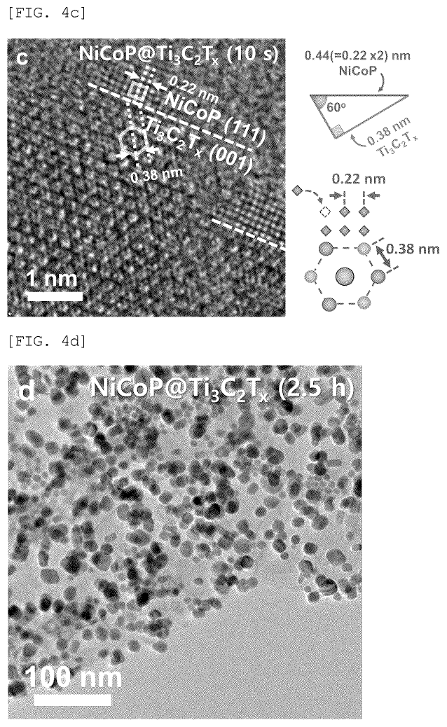

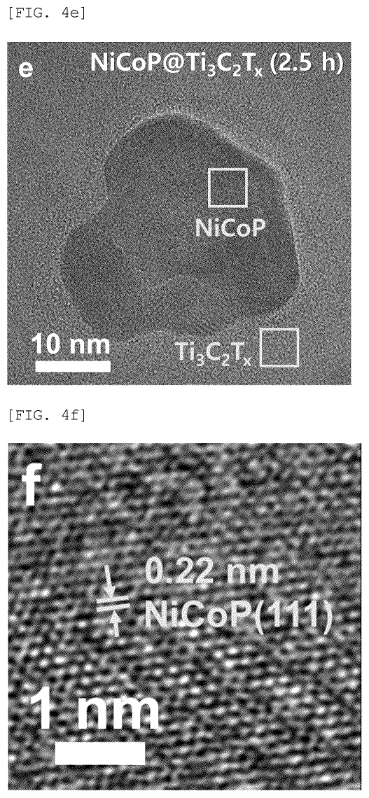

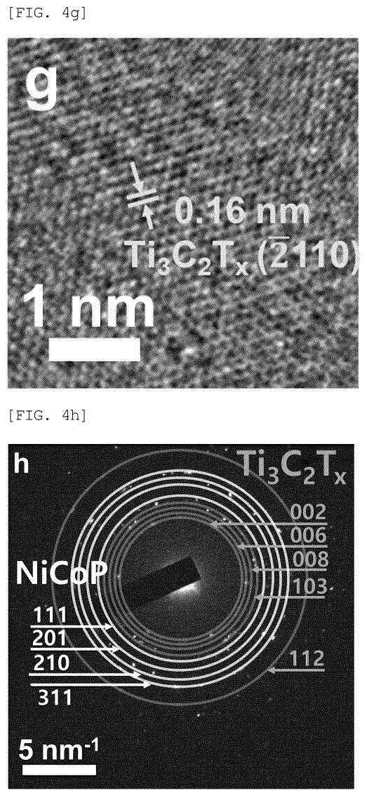

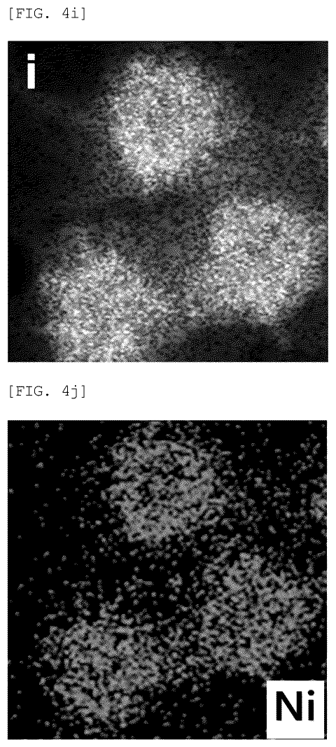

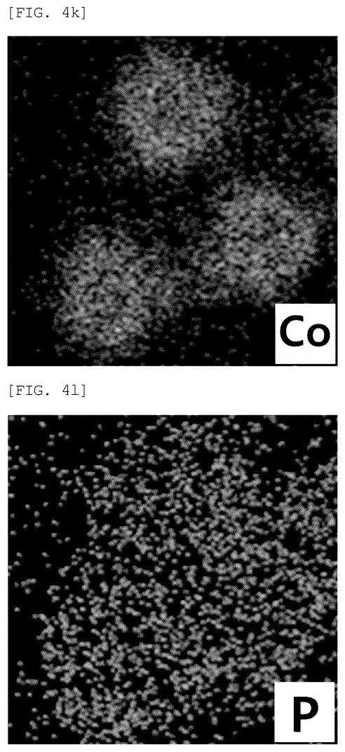

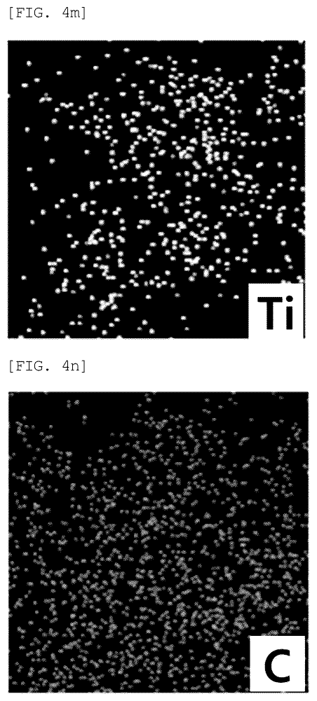

Referring to FIGS. 4a to 4n, FIG. 4a shows a MXene (Ti₃C₂Tₓ) support, which are photographed by a transmission electron microscope (TEM) at 1 nm scale.

FIGS. 4b and 4c shows electrocatalysts for water electrolysis prepared by growing an embodiment 2 (NiCoP@Ti₃C₂Tₓ) for 10 seconds, which are photographed by a TEM at 50 nm and 1 nm scale.

FIGS. 4d, 4e and 4f, 4g shows electrocatalysts for water electrolysis prepared by growing an embodiment 2 (NiCoP@Ti₃C₂Tₓ) for 2 hours, which are photographed by a TEM at 100 nm, 10 nm, 1 nm scale with a mark of NiCoP and Ti₃C₂Tₓ.

The TEM images (FIGS. 4a to 4g) showed that nickel cobalt phosphide (NiCoP) was grown in a direction of a specific crystal plane at several nano levels on the surface of the MXene (Ti₃C₂Tₓ) having a two-dimensional structure with the induced surface defects, and (001) plane of the MXene corresponds to (111) plane of NiCoP.

Theoretically, as shown in FIG. 4c, it means that a stable geometric structure is formed between a double (0.44 nm) of an inter-lattice distance of 0.22 nm on the (111) plane of NiCoP and an inter-lattice distance of 0.38 nm on the (001) plane of the MXene.

Referring to FIGS. 4d to 4g, when the electrocatalyst for the water electrolysis grown for 2 hours and 30 minutes according to the embodiment 2 (NiCoP@Ti₃C₂Tₓ) was photographed by the TEM with different magnifications, NiCoP of about 30 nm grown on the surface of the MXene was confirmed as the complex structure, and unique inter-lattice distances and crystal planes of NiCoP and MXene were confirmed in FIGS. 4f to 4g.

Further, the crystal planes of the MXene and NiCoP were confirmed through the selected area electron diffraction (SAED) analysis using the TEM as shown in FIG. 4h, and the successful formation of the NiCoP@Ti₃C₂Tₓ complex was confirmed by visually checking the distribution of elements through energy dispersive X-ray spectroscopy (EDX) coupled to the TEM as shown in FIGS. 4i to 4n ((4i) All, (4j) Nickel, (4k) Cobalt, (4l) Phosphorus, (4m) Titanium, (4n) Carbon).

### Crystal Growth

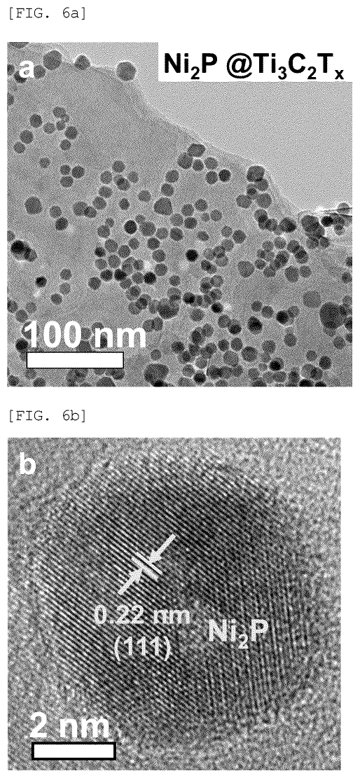

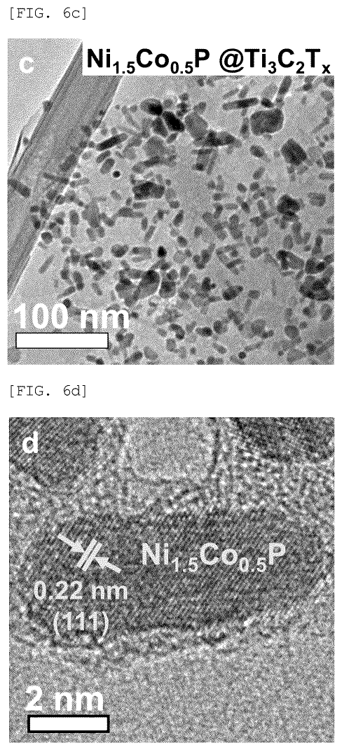

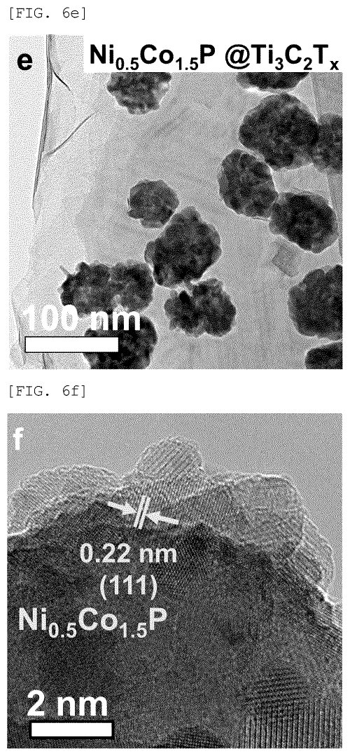

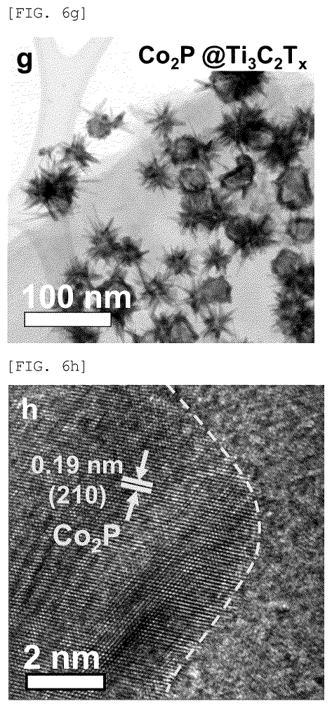

FIGS. 6a to 6h shows TEM images of an electrocatalyst for water electrolysis to analyze morphological differences and crystallographic differences according to content ratios of Ni:Co ((6a to 6b) Ni₂P@Ti₃C₂Tₓ complex, (6c to 6d) Ni_{1.5}Co_{0.5}P@Ti₃C₂Tₓ complex, (6e to 6f) Ni_{0.5}Co_{1.5}P@Ti₃C₂Tₓ complex, and (6g to 6h) Co₂P@Ti₃C₂Tₓ complex).

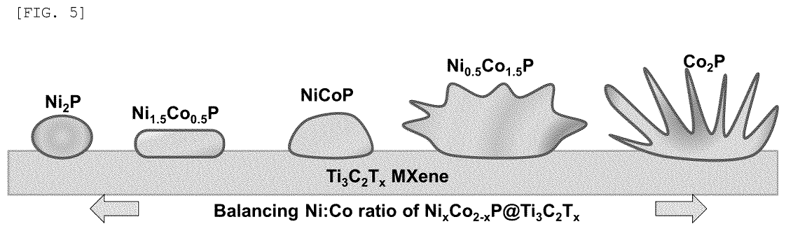

Referring to FIGS. 6a to 6h, high Ni content results in a spherical shape due to three-dimensional growth, and increase in Co content induces the growth in a specific direction and results in a shape having a one-dimensional structure, which is illustrated in FIG. 5.

In particular, Co₂P@Ti₃C₂Tₓ shows an inter-lattice distance of 0.19 nm on a (210) plane of Co₂P clearly.

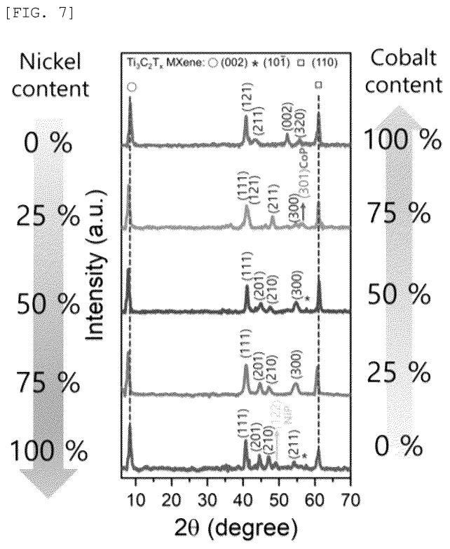

Referring to FIG. 7, it was confirmed that peaks indicating (002), (110) and (101) of the MXene (Ti₃C₂Tₓ) were seen at 7.8°, 57.5°, and 61.2°, respectively, and a plurality of peaks indicating hexagonal NiCoP were seen in a range of 40 to 55°.

Further, it was confirmed that peaks indicating NiP and CoP are seen in Ni₂P@Ti₃C₂Tₓ and Ni_{0.5}Co_{1.5}P@Ti₃C₂Tₓ, and thus the NiCoP@Ti₃C₂Tₓ complexes with various compositions were successfully formed by controlling Ni:Co content ratios.

### Oxidation State Analysis

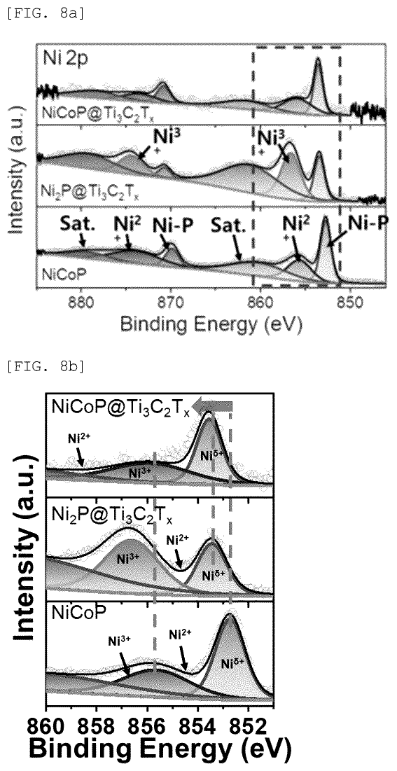

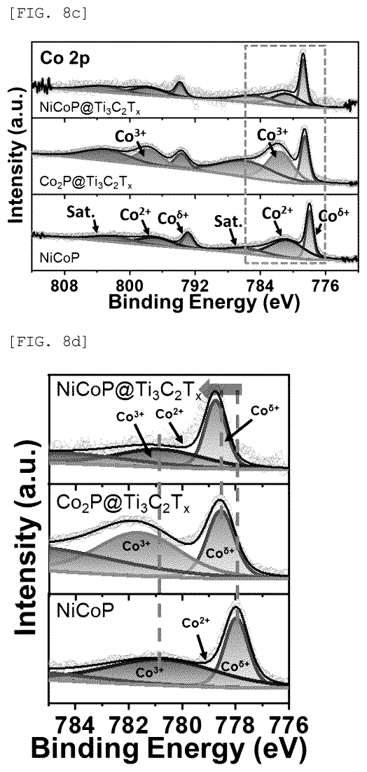

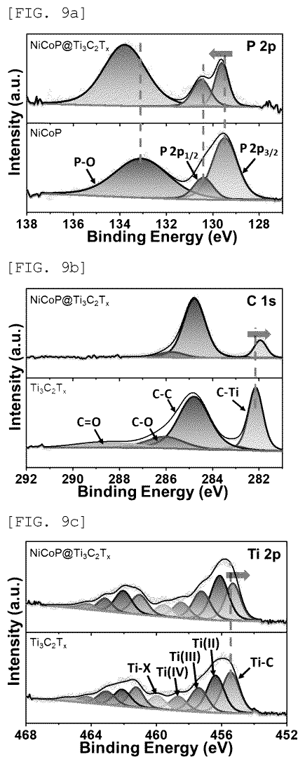

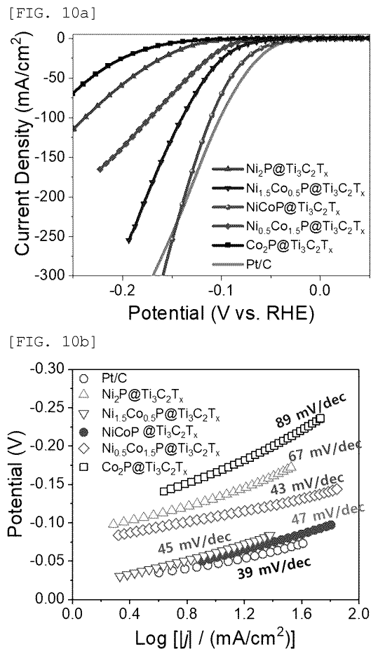

FIGS. 8a to 8d shows oxidation states related to Ni 2p(8a to 8b) and Co 2p(8c to 8d), analyzed by X-ray photoelectron spectroscopy (XPS) along with the comparative examples 1 and 2 and NiCoP synthesized without the MXene support to analyze the oxidation states of NiCoP@Ti₃C₂Tₓ complex (embodiment 2) and the comparative examples 1 and 2, and FIGS. 9a to 9c shows oxidation states related to P 2p(FIG. 8a), C 1s(FIG. 8b) and Ti 2p(FIG. 8c), analyzed by X-ray photoelectron spectroscopy (XPS) along with the comparative examples 1 and 2, NiCoP synthesized without the MXene support, or MXene (Ti₃C₂Tₓ) as a support to analyze the oxidation states of NiCoP@Ti₃C₂Tₓ complex (embodiment 2) and the comparative examples 1 and 2.

FIGS. 8a to 8b shows that Ni is in a state of Ni^{δ+} (0<δ<2) as the peak indicating Ni—P binding is located at a lower binding energy than Ni²⁺, and likewise FIGS. 8c to 8d shows that Co is also in a state of Co^{δ+} (0<δ<2) as Co—P binding is located at a lower binding energy than Co²⁺.

NiCoP, which did not form a complex along with the MXene, is in a 3-valent electronic state for each of Ni and Co, and metal (Ni or Co)—P binding is located at a lower binding energy compared to the embodiment 2.

FIGS. 9b to 9c shows that C and Ti of the MXene were shifted to lower energy after forming the complex, thereby clarifying that transfer of electrons were transferred from NiCoP to the MXene. FIG. 9a also shows that both P—O binding and P—(P 2p_{1/2} and P 2p_{3/2}) were shifted to higher binding energy after forming the complex with the MXene, but the shifts were slight compared to those of Ni and Co shown in FIGS. 9b to 9c.

With this, a P site with a biased electron cloud shows higher adsorption characteristics to hydrogen ions, and Ni and Co sites with high electron affinity show higher adsorption characteristics to hydroxide ions.

### Water Electrolysis Reaction Activities (Compared to Platinum Catalyst, Pt/C)

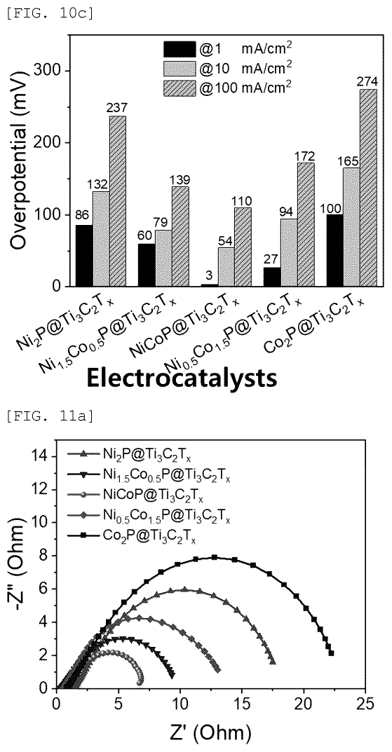

FIG. 10a shows polarization curves measured through linear sweep voltammetry (LSV) for water electrolysis HER in 1M KOH (˜pH 13.9) electrolyte by measuring electrochemical response currents of the embodiments and comparative examples including NiCoP@Ti₃C₂Tₓ (embodiment 2) complex and commercialized HER platinum catalysts (Pt/C) as a comparative group.

FIG. 10b shows Tafel slopes plotted based on the polarization curves for water electrolysis HER in 1M KOH (˜pH 13.9) electrolyte by measuring electrochemical response currents of the embodiments and comparative examples including NiCoP@Ti₃C₂Tₓ (embodiment 2) complex and commercialized HER platinum catalysts (Pt/C) as a comparative group.

FIG. 10c shows overpotential graphs at specific current density plotted based on the polarization curves of activities for water electrolysis HER in 1M KOH (˜pH 13.9) electrolyte by measuring electrochemical response currents of the embodiments and comparative examples including NiCoP@Ti₃C₂Tₓ (embodiment 2) complex and commercialized HER platinum catalysts (Pt/C) as a comparative group.

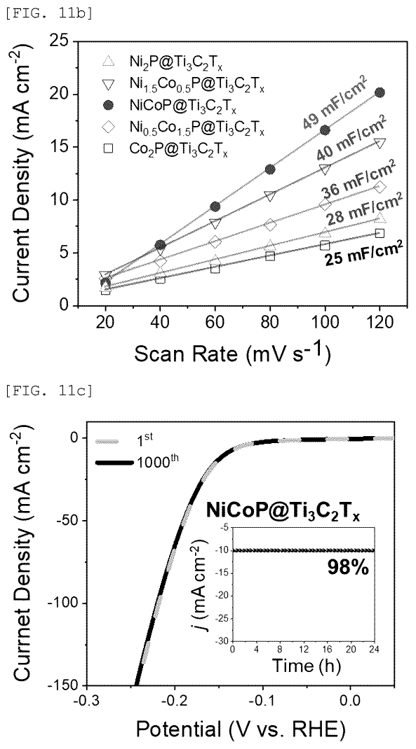

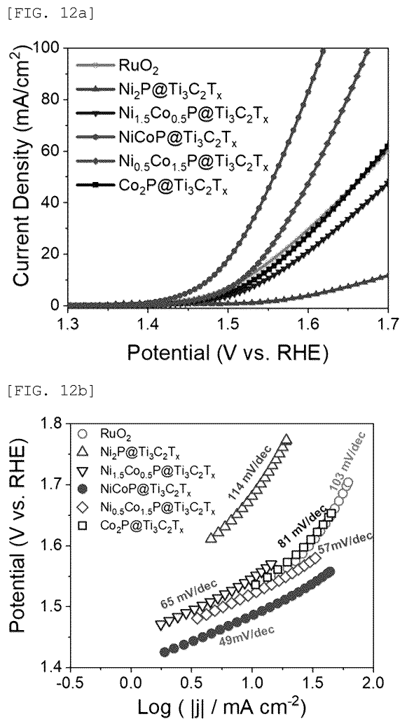

Further, FIG. 11a shows Nyquist plot based on electrochemical impedance spectroscopy (EIS) measurement for water electrolysis HER in 1 M KOH (˜pH 13.9) electrolyte by measuring electrochemical response currents of the embodiments and comparative examples including NiCoP@Ti₃C₂Tₓ (embodiment 2) complex and commercialized HER platinum catalysts (Pt/C) as a comparative group.

FIG. 11b shows electrochemical double-layer capacitance per unit area based on electrochemical active surface area (ECSA) measurement for water electrolysis HER in 1 M KOH (˜pH 13.9) electrolyte by measuring electrochemical response currents of the embodiments and comparative examples including NiCoP@Ti₃C₂Tₓ (embodiment 2) complex and commercialized HER platinum catalysts (Pt/C) as a comparative group.

FIG. 11c shows long-term operating stability evaluation graphs of activities for water electrolysis HER in 1 M KOH (˜pH 13.9) electrolyte by measuring electrochemical response currents of NiCoP@Ti₃C₂Tₓ (embodiment 2) complex and commercialized HER platinum catalysts (Pt/C) as a comparative group including NiCoP synthesized without the MXene support.

With this, NiCoP@Ti₃C₂Tₓ having a Ni:Co ratio of 1:1 exhibited superior performance compared to complex catalysts of other content, and showed similar modification, excellent electrochemical response current, Tafel slope, and low overpotential (54 mV at 10 mA/cm²) compared too Pt/C in the hydrogen evolution reaction (HER).

Therefore, NiCoP@Ti₃C₂Tₓ is proven to be an effective HER catalyst applicable to AEM water electrolysis based on excellent hydrogen ion adsorption while replacing a precious platinum catalyst (Pt/C).

In Nyquist plot (see FIG. 11a), NiCoP@Ti₃C₂Tₓ shows the smallest semicircle, which suggests the excellent charge transfer ability.

In addition to the excellent electrochemically active area, as shown in the graph of FIG. 11b, NiCoP@Ti₃C₂Tₓ exhibited the same performance as initial performance even after 1,000 repeated measurements, and showed the excellent stability of 98% compared to initial stability even after the measurement for 24 hours in FIG. 11c.

### Water Electrolysis Reaction Activities (Compared to Ruthenium Catalyst)

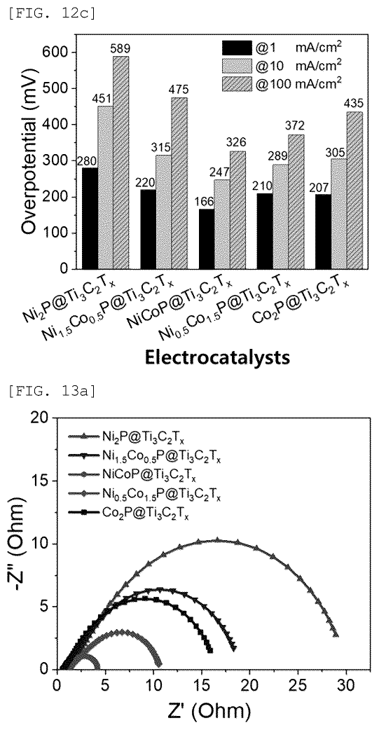

FIG. 12a shows polarization curves measured through linear sweep voltammetry (LSV) for water electrolysis OER in 1M KOH (˜pH 13.9) electrolyte by measuring electrochemical response currents of the embodiments 1 to 3 and comparative examples 1 to 2 including NiₓCo_{y}P@Ti₃C₂Tₓ complex according to nickel-cobalt compositions and commercialized OER ruthenium catalysts (RuO₂).

FIG. 12b shows Tafel slopes plotted based on the polarization curves for water electrolysis OER in 1M KOH (˜pH 13.9) electrolyte by measuring electrochemical response currents of the embodiments 1 to 3 and comparative examples 1 to 2 including NiₓCo_{y}P@Ti₃C₂Tₓ complex according to nickel-cobalt compositions and commercialized OER ruthenium catalysts (RuO₂).

FIG. 12c shows overpotential graphs at specific current density plotted based on the polarization curves of activities for water electrolysis OER in 1M KOH (˜pH 13.9) electrolyte by measuring electrochemical response currents of the embodiments 1 to 3 and comparative examples 1 to 2 including NiₓCo_{y}P@Ti₃C₂Tₓ complex according to nickel-cobalt compositions and commercialized OER ruthenium catalysts (RuO₂) as a comparative group including NiCoP synthesized without the MXene support.

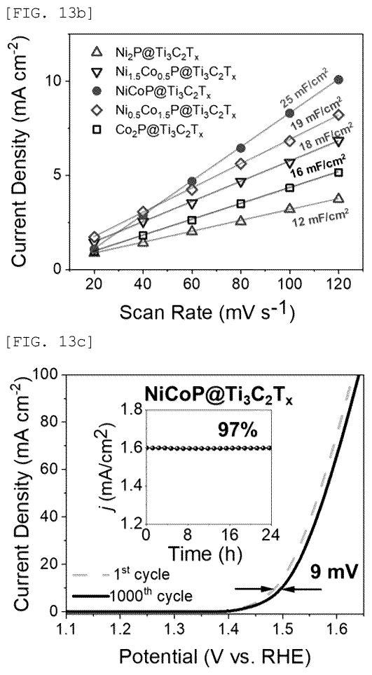

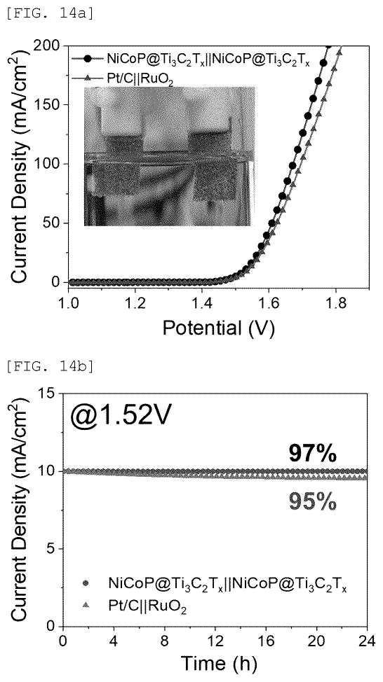

Further, FIG. 13a shows Nyquist plot based on electrochemical impedance spectroscopy (EIS) measurement for water electrolysis OER in 1 M KOH (˜pH 13.9) electrolyte by measuring electrochemical response currents of the embodiments 1 to 3 and comparative examples 1 to 2 including NiₓCo_{y}P@Ti₃C₂Tₓ complex according to nickel-cobalt compositions and commercialized OER ruthenium catalysts (RuO₂).

FIG. 13b shows electrochemical double-layer capacitance per unit area based on electrochemical active surface area (ECSA) measurement for water electrolysis OER in 1 M KOH (˜pH 13.9) electrolyte by measuring electrochemical response currents of the embodiments 1 to 3 and comparative examples 1 to 2 including NiₓCo_{y}P@Ti₃C₂Tₓ complex according to nickel-cobalt compositions and commercialized OER ruthenium catalysts (RuO₂).

FIG. 13c shows long-term operating stability evaluation graphs of activities for water electrolysis OER in 1 M KOH (˜pH 13.9) electrolyte by measuring electrochemical response currents of the embodiments 1 to 3 and comparative examples 1 to 2 including NiₓCo_{y}P@Ti₃C₂Tₓ complex according to nickel-cobalt compositions and commercialized OER ruthenium catalysts (RuO₂) as a comparative group including NiCoP synthesized without the MXene support.

NiCoP@Ti₃C₂Tₓ (embodiment 2) having a Ni:Co ratio of 1:1 exhibited superior performance compared to complex catalysts of other content, and showed excellent electrochemical response current, and low overpotential (166 mV at 10 mA/cm²) compared to RuO₂ in the oxygen evolution reaction (HER).

Therefore, NiCoP@Ti₃C₂Tₓ is confirmed as an effective OER catalyst applicable to AEM water electrolysis while replacing a precious catalyst (RuO₂).

In Nyquist plot (see FIG. 13a), NiCoP@Ti₃C₂Tₓ shows the smallest semicircle, suggests the excellent charge transfer ability, and the excellent electrochemically active area.

Further, as shown in FIG. 13c, NiCoP@Ti₃C₂Tₓ exhibited performance similar to initial performance even after 1,000 repeated measurements, maintained 99% of initial performance, in particular, for first 10 hours in the graph of FIG. 13c, and showed the excellent stability of 97% compared to initial stability even after the measurement for 24 hours.

### Water Electrolysis Reaction for Both HER and OER

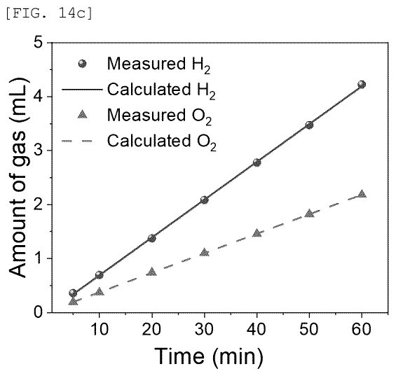

FIG. 14a shows polarization curves based on current density change according to potential (V) change, as comparative analysis results of the entire water electrolysis reaction in 1 M KOH electrolyte using NiCoP@Ti₃C₂Tₓ, i.e., an excellent bifunctional catalyst for HER and OER as an oxidation electrode and a reduction electrode and that in commercial Pt/C (reduction electrode, HER)—RuO₂ (oxidation electrode, OER).

FIG. 14b shows long-term operating stability based on the current density change over time, as comparative analysis results of the entire water electrolysis reaction in 1 M KOH electrolyte using NiCoP@Ti₃C₂Tₓ, i.e., an excellent bifunctional catalyst for HER and OER as an oxidation electrode and a reduction electrode and that in commercial Pt/C (reduction electrode, HER)—RuO₂ (oxidation electrode, OER).

FIG. 14c shows quantitative evaluation of hydrogen gas (H₂) and oxygen gas (O₂), as comparative analysis results of the entire water electrolysis reaction in 1 M KOH electrolyte using NiCoP@Ti₃C₂Tₓ, i.e., an excellent bifunctional catalyst for HER and OER as an oxidation electrode and a reduction electrode and that in commercial Pt/C (reduction electrode, HER)—RuO₂ (oxidation electrode, OER).

NiCoP@Ti₃C₂Tₓ (Ni:Co=1:1) proposed in the disclosure showed lower overpotential than commercial Pt/C—RuO₂ as shown in FIG. 14a, and maintained 97% of initial performance even after 24 hours as shown in FIG. 14b, thereby showing the excellent stability compared to the commercial Pt/C—RuO₂.

Thus, an electrochemical conversion efficiency (Faraday efficiency) of 93% is achieved based on the actually produced amounts of hydrogen and oxygen.

Accordingly, NiCoP@Ti₃C₂Tₓ (Ni:Co=1:1) proposed in the disclosure is shown to be an excellent transition metal-based bifunctional catalyst that is capable of inducing economical, stable, and highly efficient AEM water electrolysis by replacing precious metal-based commercial electrolytic catalysts such as Pt/C and RuO₂.

As described above, there are provided the electrocatalyst for the water electrolysis according to the disclosure and the method of preparing the same, in which the bimetallic phosphides having the better electrochemical activities than the commercial catalysts such as conventional transition metal oxide are used, thereby having effects on improving the operation stability and increasing electrochemical activity with the increased surface area of the catalysts.

Although specific embodiments of the disclosure have been described above in detail, the embodiments are for illustrative purposes only and do not limit the disclosure thereto, and various changes and modifications can be made therein by a person having ordinary knowledge in the art without departing from the scope of the disclosure.

Any simple modification or change in the embodiments falls within the scope of the disclosure, and the specific protection scope of the disclosure will become clear by the appended claims.

### DESCRIPTION OF REFERENCE NUMERALS

S10: MXene preparation step
S20: precursor solution preparation step
S30: complex preparation step
S40: complex washing and drying step

What is claimed is:

1. An electrocatalyst for water electrolysis, as a support-transition metal compound complex, comprising:
a support made of a MXene having a two-dimensional structure; and
a transition metal compound located on and heterogeneously bonded to the support.

2. The electrocatalyst of claim 1, wherein the transition metal compound comprises two or more metal phosphides selected from a transition metal group consisting of nickel, iron, molybdenum, cobalt and tungsten.

3. The electrocatalyst of claim 1, wherein the electrocatalyst for the water electrolysis is for a hydrogen evolution reaction (HER) or an oxygen evolution reaction (OER).

4. The electrocatalyst of claim 1, wherein the electrocatalyst for the water electrolysis is applied simultaneously to a positive electrode and a negative electrode of a water electrolysis cell.

5. The electrocatalyst of claim 1, wherein the MXene comprises a compound based on the following Formula 1: 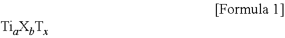
where, ‘a’ is an integer from 2 to 4, ‘b’ is an integer from 1 to 3, and ‘X’ is carbon (C) or nitrogen (N).

6. The electrocatalyst of claim 1, wherein the support has a surface modified with one or more functional groups selected from a group of functional groups (Tₓ) consisting of —O, —OH and —F.

7. A method of preparing an electrocatalyst for water electrolysis, the method comprising:
a precursor solution preparation step of preparing a precursor solution by dissolving a transition metal precursor in an organic solvent; and
a complex preparation step of preparing an electrocatalyst for water electrolysis by adding a phosphorus precursor and a MXene to the precursor solution.

8. The method of claim 7, wherein the transition metal precursor comprises two or more metal compounds comprising a metal element selected from a transition metal group consisting of nickel, iron, molybdenum, cobalt and tungsten.

9. The method of claim 7, wherein the phosphorus precursor comprises an alkyl phosphine-based material.

10. The method of claim 9, wherein the alkyl phosphine comprises one or more selected from a group consisting of triethyl phosphine, tributyl phosphine, trioctyl phosphine, triphenyl phosphine, and tricyclohexyl phosphine.

11. The method of claim 8, wherein the transition metal precursor comprises a combination of metal acetylacetonates (nickel acetylacetonate, iron acetylacetonate, molybdenum acetylacetonate, cobalt acetylacetonate, and tungsten acetylacetonate).

12. The method of claim 7, further comprising a MXene defect introduction step of inducing surface defects in the MXene by mixing a MXene precursor and strong acid before performing the complex preparation step.
